(19) United States
(12) Patent Application Publication
(10) Pub. No.: US 2025/0058371 A1
(43) Pub. Date: Feb. 20, 2025

(54) STRUCTURE WITH AN INSERT AND ASSEMBLY METHOD

(71) Applicant: The Swatch Group Research and Development Ltd, Marin (CH)

(72) Inventors: Yoann MOSTEIRO VAZQUEZ, Montmagny (CH); François ERDEMLI, Colombier (CH)

(73) Assignee: The Swatch Group Research and Development Ltd, Marin (CH)

(21) Appl. No.: 18/801,907

(22) Filed: Aug. 13, 2024

(30) Foreign Application Priority Data
Aug. 18, 2023 (EP) 23192242.8

(51) Int. Cl. B21J 1/04; B44C 1/26; G04D 1/00

(52) U.S. Cl. CPC B21J 1/04; G04D 1/00; B44C 1/26

(57) ABSTRACT

A method for assembling an insert with a recess of a structure, using a propulsion tool guiding a striker slide pushing a striker, and including a distributor device for controlling the forwards or backwards motion of the striker slide, and a tube guiding the striker and including a head with an internal profile adapted to the insert to be produced, a bar of material is inserted into the tube and heated to a predetermined temperature, a propulsion fluid is injected and a distributor slide is operated to move the striker slide at a predefined speed and to drive the striker to strike the preheated bar, force it into the recess and deform it so that it occupies the volume of the internal profile of the head.

### TECHNICAL FIELD OF THE INVENTION

The invention relates to a method for assembling an insert with a structure.

The invention further relates to a structure including at least one insert, the assembly of said insert with said structure being carried out according to this method.

The invention relates to the field of the secure assembly of attached components, in particular for the watchmaking or jewellery industry.

### Technological Background

Fastening attached components to small structures is always tricky, especially when such a structure is worn by a user, as in the case of a watch or piece of jewellery, and when any element that is protruding, or at least peripheral, is subject to shear stress, vibration or even impacts.

An irreversible attachment is not always possible when looking to guarantee a secure attachment, and in this case a high level of resistance to external stresses must be reconciled with a reversible attachment, which may be necessary in order to maintain the object, or to change its appearance.

Moreover, some materials, such as amorphous metals, do not lend themselves well to conventional assembly surfaces such as threads. However, the use of these materials can bring other advantages, making it necessary to use a suitable attachment.

### SUMMARY OF THE INVENTION

The purpose of the invention is to securely and reversibly attach an insert to a structure, particularly in the preferred but non-limiting case of a watchmaking or jewellery structure, and even more particularly in the case of inserts made of uncommon materials, such as amorphous metals or the like.

To this end, the invention relates to a method for assembling an insert provided with an elongate part ending in a head in a distal part, with a recess of a structure, which method uses a propulsion tool guiding a first striker slide pushing a striker in the form of a free projectile, and including a distributor device for controlling the forwards or backwards motion of said first striker slide, and a tube guiding said striker and said tube including a head with an internal profile adapted to the head of the insert to be produced; according to which method a bar of material made of an at least partially amorphous material is inserted into the tube, said bar of material being intended to form said insert, said bar is heated to a predetermined temperature, a propulsion fluid is injected into said propulsion tool and a second distributor slide comprised in said propulsion tool is operated to move the first striker slide at a predefined speed and to drive the striker by percussion which, as it moves in the tube, strikes the preheated bar which moves in the tube until it is forcibly inserted into said recess and is deformed so that it occupies the volume of said internal profile of said head.

Another aspect of the invention relates to a structure including at least one insert arranged in a recess, the assembly of said insert with said structure being carried out according to the method as defined above, characterised in that said structure is a watchmaking or jewellery component, in that said insert is an assembly screw including a body and a head, in that the assembly screw is made of an amorphous alloy, in that said recess has an internal thread, in that said recess has a roughness greater than 6 micrometres Ra and in that the assembly screw has an indentation in its distal part which forms said head for its removal. It should be noted that the head and the body of the screw can have the same or different diameters, in which case the head has a larger diameter.

### BRIEF DESCRIPTION OF THE FIGURES

The aims, advantages and features of the invention will become clearer from the detailed description that follows, which is given with reference to the accompanying drawings, where:

FIG. 1 diagrammatically shows a plan view of the arrangement of a propulsion tool and of a specific tube in frontal contact with a structure, in order to make and attach an insert;

FIG. 2 diagrammatically shows a cross-sectional view of the same assembly along plane A-A of FIG. 1; the propulsion tool on the right-hand side of the figure contains a distributor controlling the movement of a striker slide to push a striker, shown here at the boundary between the propulsion tool and the tube; this tube is shown with the insert taking two different states: a bar of material can be seen close to the left end of the tube, which bar of material is suitable for producing the insert and is ready to be heated and then struck by the striker, whereas the left-hand side of the figure shows the insert produced by transforming this bar of material, after it has been shaped, with its inner part in a recess provided in the structure for receiving this insert, and its outer part in an internal profile of the head of the tube, applied against one face of the structure, the outer part of the insert still including, substantially along its axis, an indentation made by the nose of the striker during percussion;

FIG. 3 diagrammatically shows a side view of the same assembly, with nozzles for injecting or extracting fluid, in particular a gas, in particular air;

FIG. 4 diagrammatically shows a side view of the tube in which the bar of material is transformed into an insert;

FIG. 5 diagrammatically shows a side view of the distributor sleeve of the propulsion tool;

FIG. 6 diagrammatically shows a side view of the striker slide;

FIG. 7 diagrammatically shows a side view of the striker.

### DETAILED DESCRIPTION OF THE INVENTION

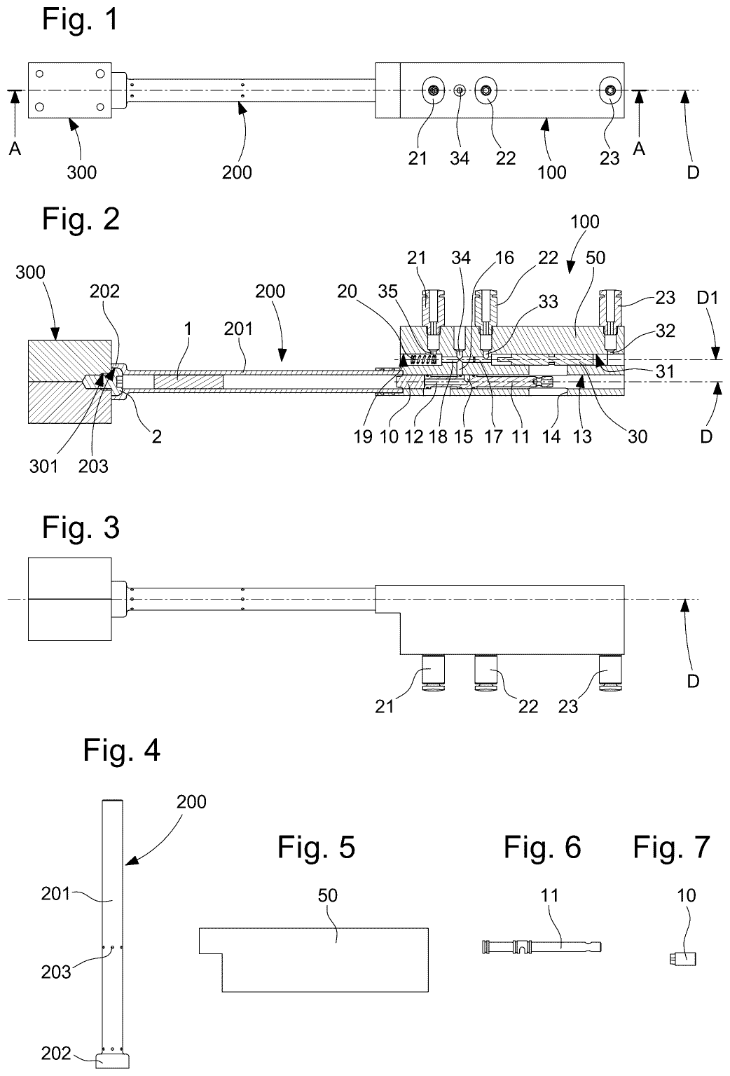

FIGS. 1 to 3 show a diagrammatic view of the assembly consisting of a structure 300 in which an insert 2 will be formed from a bar of material 1, and attached, by a tube 200 in which a striker 10 circulates, capable of carrying out this shaping and this attachment, under the action of a fluid-controlled distributing propulsion tool 100. The fluidic control can be hydraulic or pneumatic, depending on the size of the facility. For a watchmaking or jewellery application, as illustrated non-limitatively by the figures, pneumatic control can be sufficient to supply the energy required for the movement of the striker. In this case, the fluid conveyed is a gas, in particular air. For more complex, special, mechanical applications, for example for equipment assemblies in nuclear power stations or the like, fluidic control must be hydraulic, in which case the fluid used is oil. For other applications, the fluid can be a liquid, a gas or a plasma. The example of air, which is used in the embodiment illustrated in the figures, is by no means limiting.

The invention relates more particularly to a method for assembling an insert 2 with a structure 300.

According to this method, a recess 301 is created in the structure 300 to receive this insert 2.

A bar of material 1 is provided to produce this insert 2.

The method for assembling such an insert 2 with such a recess 301 of a structure 300 uses a propulsion tool 100. This propulsion tool 100 guides a first striker slide 11 pushing a striker 10, and includes a distributor device for controlling the forwards or backwards motion of the first striker slide 11. The propulsion tool 100 includes a tube 200 guiding this striker 10, and including a head 202 with an internal profile 203 adapted to the insert 2 to be produced.

According to this method, a bar of material 1 is inserted into the tube 200 and heated to a predetermined temperature, a propulsion fluid is injected and a second distributor slide 30 is operated to move the first striker slide 11 at a predefined speed and drive the striker 10 so that it strikes the preheated bar 1, forces it into the recess 301 and deforms it so that it occupies the volume of the internal profile 203 of said head 202.

More particularly and in a non-limiting manner, a propulsion tool 100 is provided, which tool includes a sleeve 50 which includes, on the one hand, a first cylindrical chamber 13 in which a first striker slide 11 is movable, which striker slide is arranged to axially push a striker 10 in a striking direction D, and, on the other hand, a distributor device including a second chamber 31 supplied with fluid by injection or extraction nozzles 21, 22, 23, and in which a second distributor slide 30 is axially movable in a striking direction D, and secondly a distributor device including a second chamber 31 supplied with fluid by injection or extraction nozzles 21, 22, 23, and in which a second distributor slide 30 is axially movable in a distribution direction D1 parallel to said striking direction D to control the forwards or backwards motion of the first striker slide 11.

A tube 200 is provided including, on a first side, a cylindrical body 201 including a bore arranged to extend the first chamber 13 and to guide the striker 10, and, on a second side, a head 202 with an internal profile 203 adapted to the shape of the insert 2 to be produced.

The tube 200 is attached by its first side to the propulsion tool 100, and the head 202 is placed such that it bears against the structure 300, aligning the recess 301 with the striking direction D.

The bar of material 1 is inserted into the cylindrical body 201, a heating element is placed around the cylindrical body 201, and the bar of material 1 is heated to a predetermined temperature.

A propulsion fluid is then injected into at least one of the injection or extraction nozzles 21, 22, 23, and the second distributor slide 30 is operated to move the first striker slide 11 at a predefined speed, and to drive the striker 10 to strike the preheated bar of material 1 and force it into the recess 301, and deform it so that it occupies the entire volume of the internal profile 203 of the head 202.

More particularly, the preheated bar of material 1 is brought to bear against the structure 300, before being forced into the recess 301 by the action of the striker 10. Even more particularly, the preheated bar of material 1 is brought to bear against the structure 300 by fluid pressure.

Thanks to its movement and the induced pressure it generates, the striker 10 allows the material to be pre-positioned in its final recess 301. An exhaust allows this pressure to be released in order to carry out a striking and shaping phase. The striker 10 acts substantially like a forming hammer on a press. The striker 10 is free in the example shown, but must be brought back into position.

The propulsion tool 100 has various channels 33, 34 for bringing fluid into communication with the grooves of the slides.

More particularly, the bar of material 1 is made of at least partially amorphous material. Even more particularly, the bar of material 1 is made of amorphous metal.

More particularly, an induction heating element is used.

More particularly, the predefined speed is chosen to be between 1 m/s and 5 m/s.

More particularly, said predetermined temperature is chosen between 400° C. and 600° C., depending on the nature of the bar of material 1, to bring the preheated bar of material 1 into a viscous phase.

Even more particularly, the recess 301 is made with an internal thread or with a macro-relief for hooking. Even more particularly, this recess 301 is made with an internal thread, the profile and pitch whereof require the use of ultrasound at a predetermined frequency for its removal in combination with the application of a mechanical torque via a suitable tool.

More particularly, the recess 301 is made with a roughness greater than 6 micrometres Ra. For example, the simple grooves of a bore can suffice.

Even more particularly, a striker 10 is chosen which has a relief capable of forming an indentation in the insert 2 which allows this insert 2 to be manipulated by a spanner or screwdriver with a profile that complements this indentation.

More particularly, the insert 2 is produced in the form of an assembly screw.

More particularly, the insert 2 is produced in the form of a setting. More particularly, this setting is produced with an indentation for its removal, this indentation being surmounted, on the side opposite the recess 301, by a setting ring and/or setting claws.

More particularly, said second distributor slide 30 is arranged coaxially with a third slide 17 which is arranged to control the release of the propulsion fluid when it is pushed by the second distributor slide 30, against a resilient return means 20. This mechanism allows pressure to be released after the striker 10 has been moved away from its insertion zone. The movement of the second distributor slide 30 drives the first striker slide 11, and when the second distributor slide 30 comes into contact with the third slide 17, it releases the propulsion gas.

The invention further relates to a structure 300 including at least one insert 2, the assembly of the insert 2 with the structure 300 being carried out according to this method. More particularly, this structure 300 is a watchmaking or jewellery component.

The invention thus makes it possible to produce a reversible assembly, in particular by injecting amorphous metal, in order to form a screw-like attachment directly from a bar in a pre-assembly.

In short, the system includes a propulsion tool that transmits mechanical energy to the striker, which, driven at a defined speed, comes into contact with the bar of material, particularly but not exclusively amorphous metal, which has been previously heated (and which can, depending on the case, have been previously displaced in the pre-assembled orifice, by means of air pressure for example). The striker forms an indentation in the insert thus obtained.

This insert, in particular an attaching insert, can take different forms: an assembly screw as typically used, a decorative element without the need for assembly (for example an applique, an inlaid decoration), an ornamental support, for example a precious stone in the case of the formation of a setting, and in particular a combination of a screw-type attachment system and a diamond setting, for which, if dismantling is required, once the diamond has been removed from the setting, a special tool can be used to unscrew the element. This insert can be fitted with a special thread to secure removal, i.e. a shape with a specific tip, or by using ultrasound at a specific frequency.

The shaping of the material, particularly amorphous metal, by the striker is facilitated by the high speed of the striker in the tube.

The invention makes it possible to manufacture an insert, in particular a screw, which can be removed directly in position in the assembly, and which is in particular made of amorphous metal.

The recess of the insert is advantagesouly produced with a special reversible thread for a directly injected screw.

The striker is simple and inexpensive, making it easy to manufacture insert heads of any shape, and with a completely customisable indentation.

Removal of the insert is made more secure (without a standardised indentation) by the use of ultrasound at a specific frequency.

1. A method for assembling an insert provided with an elongate part ending in a head with a recess of a structure, which method uses a propulsion tool guiding a first striker slide pushing a striker in the form of a free projectile, and including a distributor device for controlling the forwards or backwards motion of said first striker slide, and a tube guiding said striker and said tube including a head with an internal profile adapted to the head of the insert to be produced; according to which method a bar of material made of an at least partially amorphous material is inserted into the tube, said bar of material being intended to form said insert, said bar is heated to a predetermined temperature, a propulsion fluid is injected into said propulsion tool and a second distributor slide comprised in said propulsion tool is operated to move the first striker slide at a predefined speed and to drive the striker by percussion, which, as it moves in the tube, strikes the bar which moves in the tube until the bar is forcibly inserted into said recess and is deformed so that the bar occupies the volume of said internal profile of said head.

2. The assembly method according to claim 1, wherein said recess is created in said structure to receive said insert, a said bar of material is provided to produce said insert, a propulsion tool is provided, which propulsion tool includes a first cylindrical chamber wherein the first striker slide can move, which striker slide is arranged to push the striker axially in a striking direction (D), and includes a distributor device for controlling the forwards or backwards motion of said first striker slide, a said tube is provided including, on a first side, a cylindrical body including a bore arranged to extend said first chamber and to guide said striker, and on a second side, a said head with a said internal profile adapted to said insert to be produced, said tube is attached by its said first side to said propulsion tool, and said head is brought to bear against said structure by aligning said recess with said striking direction (D), said bar of material is inserted into said cylindrical body, a heating element is placed around said cylindrical body, said bar of material is heated to a predetermined temperature, a propulsion fluid is injected into at least one of said injection or extraction nozzles, and the operation of said second distributor slide is controlled in order to move said first striker slide at a predefined speed, and to drive said striker in order to strike said bar of material and force the bar into said recess, and deform the bar so that it occupies the entire volume of said internal profile of said head.

3. The assembly method according to claim 2, wherein a heating element is used, which heating element is an induction heating element.

4. The assembly method according to claim 2, wherein said propulsion tool is produced such that said propulsion tool includes a sleeve which includes said first cylindrical chamber wherein said first striker slide is movable, said sleeve further including said distributor device including a second chamber supplied with fluid by injection or extraction nozzles and wherein a second distributor slide is axially movable in a distribution direction (D1) parallel to said striking direction (D) to control the forwards or backwards motion of said first striker slide.

5. The assembly method according to claim 1, wherein said bar of material is brought to bear against said structure, before the bar is forced into said recess under the action of said striker.

6. The assembly method according to claim 5, wherein said bar of material is brought to bear against said structure by fluid pressure.

7. The assembly method according to claim 1, wherein said bar of material is made of at least partially amorphous material.

8. The assembly method according to claim 1, wherein said recess is produced with an internal thread or with a macro-relief for hooking.

9. The assembly method according to claim 8, wherein said recess is produced with an internal thread, the profile and pitch whereof require the use of ultrasound at a predetermined frequency for its removal in combination with the application of a mechanical torque via a suitable tool.

10. The assembly method according to claim 1, wherein said recess is produced with a roughness greater than 6 micrometres Ra.

11. The assembly method according to claim 1, wherein a said striker including a relief is chosen, which relief is capable of forming, in said insert, an indentation allowing said insert to be manipulated by a spanner or screwdriver with a profile that complements said indentation.

12. The assembly method according to claim 1, wherein said insert is produced in the form of an assembly screw.

13. The assembly method according to claim 1, wherein said insert is produced in the form of a setting.

14. The assembly method according to claim 13, wherein said setting is produced with an indentation for its removal, said indentation being surmounted, on the side opposite said recess, by a setting ring and/or setting claws.

15. The assembly method according to claim 1, wherein said predefined speed is chosen between 1 m/s and 5 m/s.

16. The assembly method according to claim 1, wherein said predetermined temperature is chosen between 400° C. and 600° C., depending on the nature of said bar of material, in order to bring said preheated bar of material into a viscous phase.

17. The assembly method according to claim 1, wherein said second distributor slide is arranged coaxially with a third slide which is arranged to control the release of the propulsion fluid when said propulsion fluid is pushed by said second distributor slide, against a resilient return.

18. A structure comprising at least one insert arranged in a recess, the assembly of said insert with said structure being carried out according to the method according to claim 1, wherein said structure is a watchmaking or jewellery component, wherein said insert is an assembly screw, the assembly screw being made of an amorphous alloy, said recess having an internal thread, said recess having a roughness greater than 6 micrometres Ra and the assembly screw having an indentation in its distal part for its removal.
